(19) United States
(12) Patent Application Publication
(10) Pub. No.: US 2019/0279108 A1
(43) Pub. Date: Sep. 12, 2019

(54) MACHINE MODELING SYSTEM AND METHOD

(71) Applicant: Public Utility District No. 1 of Chelan County, WA, Wenatchee, WA (US)

(72) Inventors: JOHN BARTLEY YALE, Wenatchee, WA (US); Alisa Noelle Reimer, Spokane, WA (US); Scott Bevel Smyth, Liberty Lake, WA (US); Kirsten Kinyon Gable, Spokane, WA (US)

(21) Appl. No.: 16/297,034

(22) Filed: Mar. 8, 2019

Related U.S. Application Data
(60) Provisional application No. 62/640,126, filed on Mar. 8, 2018.

(51) Int. Cl. G06N 20/00; G06N 7/00; G06N 5/02

(52) U.S. Cl. CPC G06N 20/00; G06N 5/02; G06N 7/005

(57) ABSTRACT

A computer-implemented method, computer program product and computing system for monitoring observed data for at least one electricity-producing machine that is operating in one or more monitored performance envelopes; and processing the observed data to generate a performance model for the at least one electricity-producing machine.

### RELATED APPLICATION(S)

This application claims the benefit of U.S. Provisional Application No. 62/640,126, filed on 8 Mar. 2018, the entire contents of which is herein incorporated by reference.

### TECHNICAL FIELD

This disclosure relates to probabilistic models and, more particularly, to the automated generation of probabilistic models.

### BACKGROUND

The use of Artificial Intelligence (AI) and Machine Learning (ML) has revolutionized the manner in which large quantities of content may be processed so that information may be extracted that is not readily discernible to a human user. Accordingly and though the use of AI/ML, businesses may receive and process large quantities of content to look for such “hidden” information.

In the industrial world, electrical machinery/mechanical machinery/electromechanical machinery may be used, wherein the manner in which such machinery is used may have various impacts on the machinery, examples of which may include but are not limited to: the overall lifespan of the machinery; the maintenance schedule of the machinery; the failures experienced by the machinery; the efficiency of the machinery; and the reliability of the machinery.

Accordingly, Artificial Intelligence (AI) and Machine Learning (ML) may be utilized to process and analyze data that is received from such machinery to provide some insight into such impacts.

### SUMMARY OF DISCLOSURE

In one implementation, a computer-implemented method is executed on a computing device and includes: monitoring observed data for at least one electricity-producing machine that is operating in one or more monitored performance envelopes; and processing the observed data to generate a performance model for the at least one electricity-producing machine.

One or more of the following features may be included. The performance model for the at least one electricity-producing machine may be adapted to be applicable with a different electricity-producing machine. Adapting the performance model for the at least one electricity-producing machine to be applicable with a different electricity-producing machine may include processing a data set produced by the different electricity-producing machine using the performance model for the at least one electricity-producing machine to produce a result set. Adapting the performance model for the at least one electricity-producing machine to be applicable with a different electricity-producing machine may further include modifying the performance model for the at least one electricity-producing machine, based at least in part upon the result set, to produce a performance model for the different electricity-producing machine. The performance model may be utilized to predict operational performance data for the at least one electricity-producing machine when it is operating in a different performance envelope than the one or more monitored performance envelopes. The operational performance data may include one or more of: sensor data for the at least one electricity-producing machine when it is operating in the different performance envelope; longevity data for the at least one electricity-producing machine when it is operating in the different performance envelope; efficiency data for the at least one electricity-producing machine when it is operating in the different performance envelope; output data for the at least one electricity-producing machine when it is operating in the different performance envelope; and maintenance data for the at least one electricity-producing machine when it is operating in the different performance envelope. Monitoring observed data for at least one electricity-producing machine that is operating in one or more monitored performance envelopes may include monitoring a plurality of data sensors coupled to the at least one electricity-producing machine to obtain the observed data.

In another implementation, a computer program product resides on a computer readable medium and has a plurality of instructions stored on it. When executed by a processor, the instructions cause the processor to perform operations including monitoring observed data for at least one electricity-producing machine that is operating in one or more monitored performance envelopes; and processing the observed data to generate a performance model for the at least one electricity-producing machine.

One or more of the following features may be included. The performance model for the at least one electricity-producing machine may be adapted to be applicable with a different electricity-producing machine. Adapting the performance model for the at least one electricity-producing machine to be applicable with a different electricity-producing machine may include processing a data set produced by the different electricity-producing machine using the performance model for the at least one electricity-producing machine to produce a result set. Adapting the performance model for the at least one electricity-producing machine to be applicable with a different electricity-producing machine may further include modifying the performance model for the at least one electricity-producing machine, based at least in part upon the result set, to produce a performance model for the different electricity-producing machine. The performance model may be utilized to predict operational performance data for the at least one electricity-producing machine when it is operating in a different performance envelope than the one or more monitored performance envelopes. The operational performance data may include one or more of: sensor data for the at least one electricity-producing machine when it is operating in the different performance envelope; longevity data for the at least one electricity-producing machine when it is operating in the different performance envelope; efficiency data for the at least one electricity-producing machine when it is operating in the different performance envelope; output data for the at least one electricity-producing machine when it is operating in the different performance envelope; and maintenance data for the at least one electricity-producing machine when it is operating in the different performance envelope. Monitoring observed data for at least one electricity-producing machine that is operating in one or more monitored performance envelopes may include monitoring a plurality of data sensors coupled to the at least one electricity-producing machine to obtain the observed data.

In another implementation, a computing system includes a processor and memory is configured to perform operations including monitoring observed data for at least one electricity-producing machine that is operating in one or more monitored performance envelopes; and processing the observed data to generate a performance model for the at least one electricity-producing machine.

One or more of the following features may be included. The performance model for the at least one electricity-producing machine may be adapted to be applicable with a different electricity-producing machine. Adapting the performance model for the at least one electricity-producing machine to be applicable with a different electricity-producing machine may include processing a data set produced by the different electricity-producing machine using the performance model for the at least one electricity-producing machine to produce a result set. Adapting the performance model for the at least one electricity-producing machine to be applicable with a different electricity-producing machine may further include modifying the performance model for the at least one electricity-producing machine, based at least in part upon the result set, to produce a performance model for the different electricity-producing machine. The performance model may be utilized to predict operational performance data for the at least one electricity-producing machine when it is operating in a different performance envelope than the one or more monitored performance envelopes. The operational performance data may include one or more of: sensor data for the at least one electricity-producing machine when it is operating in the different performance envelope; longevity data for the at least one electricity-producing machine when it is operating in the different performance envelope; efficiency data for the at least one electricity-producing machine when it is operating in the different performance envelope; output data for the at least one electricity-producing machine when it is operating in the different performance envelope; and maintenance data for the at least one electricity-producing machine when it is operating in the different performance envelope. Monitoring observed data for at least one electricity-producing machine that is operating in one or more monitored performance envelopes may include monitoring a plurality of data sensors coupled to the at least one electricity-producing machine to obtain the observed data.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a probabilistic modeling process according to an embodiment of the present disclosure;

FIG. 2 is a diagrammatic view of a probabilistic model rendered by the probabilistic modeling process of FIG. 1 according to an embodiment of the present disclosure;

FIG. 3 is a diagrammatic view of a probabilistic model rendered by the probabilistic modeling process of FIG. 1 according to an embodiment of the present disclosure; and

FIG. 4 is a flowchart of another implementation of the probabilistic modeling process of FIG. 1 according to an embodiment of the present disclosure.

Like reference symbols in the various drawings indicate like elements.

### DETAILED DESCRIPTION OF THE PREFERRED EMBODIMENTS

System Overview

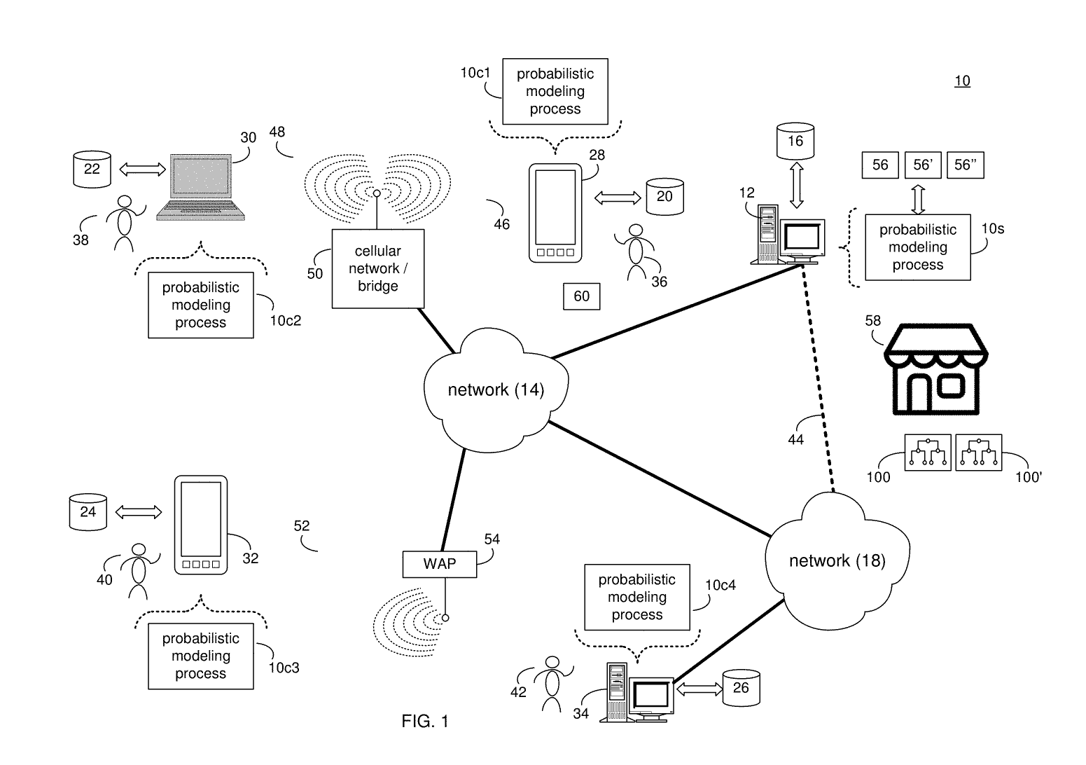

Referring to FIG. 1, there is shown probabilistic modeling process 10. Probabilistic modeling process 10 may be implemented as a server-side process, a client-side process, or a hybrid server-side/client-side process. For example, probabilistic modeling process 10 may be implemented as a purely server-side process via probabilistic modeling process 10s. Alternatively, probabilistic modeling process 10 may be implemented as a purely client-side process via one or more of probabilistic modeling process 10c1, probabilistic modeling process 10c2, probabilistic modeling process 10c3, and probabilistic modeling process 10c4. Alternatively still, probabilistic modeling process 10 may be implemented as a hybrid server-side/client-side process via probabilistic modeling process 10s in combination with one or more of probabilistic modeling process 10c1, probabilistic modeling process 10c2, probabilistic modeling process 10c3, and probabilistic modeling process 10c4. Accordingly, probabilistic modeling process 10 as used in this disclosure may include any combination of probabilistic modeling process 10s, probabilistic modeling process 10c1, probabilistic modeling process 10c2, probabilistic modeling process, and probabilistic modeling process 10c4.

Probabilistic modeling process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a cloud-based computing network.

The instruction sets and subroutines of probabilistic modeling process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of probabilistic modeling processes 10c1, 10c2, 10c3, 10c4 may include but are not limited to a client application, a web browser, a game console user interface, or a specialized application (e.g., an application running on e.g., the Android™ platform or the iOS platform). The instruction sets and subroutines of probabilistic modeling processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage device 16 may include but are not limited to: a hard disk drive; a RAID device; a random access memory (RAM); a read-only memory (ROM); and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access probabilistic modeling process 10 directly through network 14 or through secondary network 18. Further, probabilistic modeling process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Probabilistic Modeling Overview:

Assume for illustrative purposes that probabilistic modeling process 10 may be configured to process content (e.g., content 56), wherein examples of content 56 may include but are not limited to unstructured content and structured content.

As is known in the art, structured content may be content that is separated into independent portions (e.g., fields, columns, features) and, therefore, may have a pre-defined data model and/or is organized in a pre-defined manner. For example, if the structured content concerns an employee list: a first field, column or feature may define the first name of the employee; a second field, column or feature may define the last name of the employee; a third field, column or feature may define the home address of the employee; and a fourth field, column or feature may define the hire date of the employee.

Further and as is known in the art, unstructured content may be content that is not separated into independent portions (e.g., fields, columns, features) and, therefore, may not have a pre-defined data model and/or is not organized in a pre-defined manner. For example, if the unstructured content concerns the same employee list: the first name of the employee, the last name of the employee, the home address of the employee, and the hire date of the employee may all be combined into one field, column or feature.

For the following example, assume that content 56 is unstructured content, an example of which may include but is not limited to unstructured user feedback received by a company (e.g., text-based feedback such as text-messages, social media posts, and email messages; and transcribed voice-based feedback such as transcribed voice mail, and transcribed voice messages).

When processing content 56, probabilistic modeling process 10 may use probabilistic modeling to accomplish such processing, wherein examples of such probabilistic modeling may include but are not limited to discriminative modeling, generative modeling, or combinations thereof.

As is known in the art, probabilistic modeling may be used within modern artificial intelligence systems (e.g., probabilistic modeling process 10), in that these probabilistic models may provide artificial intelligence systems with the tools required to autonomously analyze vast quantities of data (e.g., content 56).

Examples of the tasks for which probabilistic modeling may be utilized may include but are not limited to:
predicting media (music, movies, books) that a user may like or enjoy based upon media that the user has liked or enjoyed in the past;
transcribing words spoken by a user into editable text;
grouping genes into gene clusters;
identifying recurring patterns within vast data sets;
filtering email that is believed to be spam from a user's inbox;
generating clean (i.e., non-noisy) data from a noisy data set;
analyzing (voice-based or text-based) customer feedback; and
diagnosing various medical conditions and diseases.

For each of the above-described applications of probabilistic modeling, an initial probabilistic model may be defined, wherein this initial probabilistic model may be subsequently (e.g., iteratively or continuously) modified and revised, thus allowing the probabilistic models and the artificial intelligence systems (e.g., probabilistic modeling process 10) to “learn” so that future probabilistic models may be more precise and may explain more complex data sets.

Accordingly, probabilistic modeling process 10 may define an initial probabilistic model for accomplishing a defined task (e.g., the analyzing of content 56). For example, assume that this defined task is analyzing customer feedback (e.g., content 56) that is received from customers of e.g., store 58 via an automated feedback phone line. For this example, assume that content 56 is initially voice-based content that is processed via e.g., a speech-to-text process that results in unstructured text-based customer feedback (e.g., content 56).

With respect to probabilistic modeling process 10, a probabilistic model may be utilized to go from initial observations about content 56 (e.g., as represented by the initial branches of a probabilistic model) to conclusions about content 56 (e.g., as represented by the leaves of a probabilistic model).

As used in this disclosure, the term “branch” may refer to the existence (or non-existence) of a component (e.g., a sub-model) of (or included within) a model. Examples of such a branch may include but are not limited to: an execution branch of a probabilistic program or other generative model, a part (or parts) of a probabilistic graphical model, and/or a component neural network that may (or may not) have been previously trained.

While the following discussion provides a detailed example of a probabilistic model, this is for illustrative purposes only and is not intended to be a limitation of this disclosure, as other configurations are possible and are considered to be within the scope of this disclosure. For example, the following discussion may concern any type of model (e.g., be it probabilistic or other) and, therefore, the below-described probabilistic model is merely intended to be one illustrative example of a type of model and is not intended to limit this disclosure to probabilistic models.

Additionally, while the following discussion concerns word-based routing of messages through a probabilistic model, this is for illustrative purposes only and is not intended to be a limitation of this disclosure, as other configurations are possible and are considered to be within the scope of this disclosure. Examples of other types of information that may be used to route messages through a probabilistic model may include: the order of the words within a message; and the punctuation interspersed throughout the message.

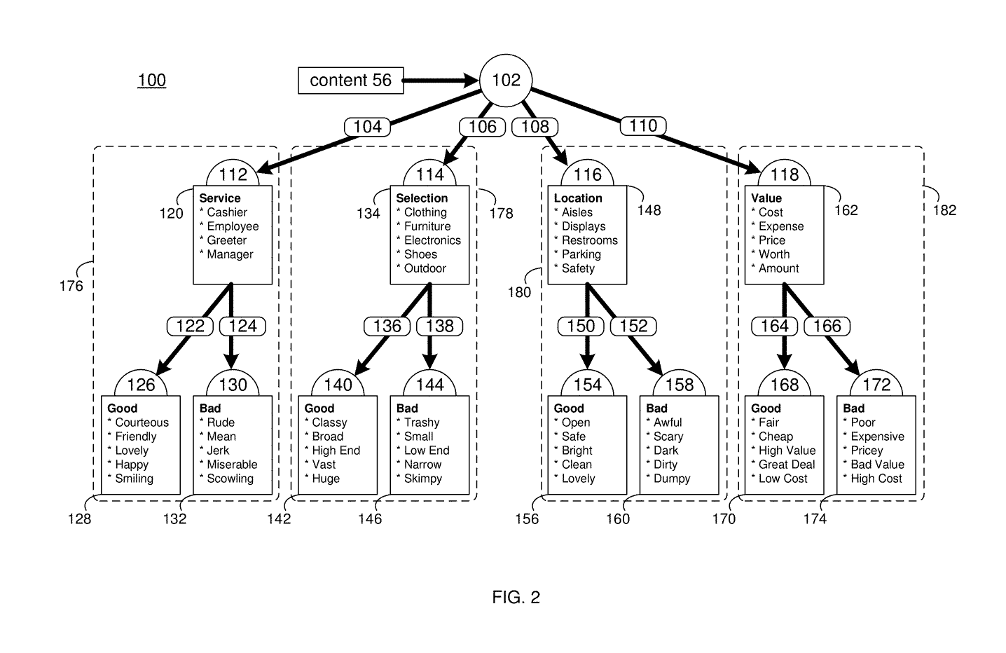

For example and referring also to FIG. 2, there is shown one simplified example of a probabilistic model (e.g., probabilistic model 100) that may be utilized to analyze content 56 (e.g. unstructured text-based customer feedback) concerning store 58. The manner in which probabilistic model 100 may be automatically-generated by probabilistic modeling process 10 will be discussed below in detail. In this particular example, probabilistic model 100 may receive content 56 (e.g. unstructured text-based customer feedback) at branching node 102 for processing. Assume that probabilistic model 100 includes four branches off of branching node 102, namely: service branch 104; selection branch 106; location branch 108; and value branch 110 that respectively lead to service node 112, selection node 114, location node 116, and value node 118.

As stated above, service branch 104 may lead to service node 112, which may be configured to process the portion of content 56 (e.g. unstructured text-based customer feedback) that concerns (in whole or in part) feedback concerning the customer service of store 58. For example, service node 112 may define service word list 120 that may include e.g., the word service, as well as synonyms of (and words related to) the word service (e.g., cashier, employee, greeter and manager). Accordingly and in the event that a portion of content 56 (e.g., a text-based customer feedback message) includes the word cashier, employee, greeter and/or manager, that portion of content 56 may be considered to be text-based customer feedback concerning the service received at store 58 and (therefore) may be routed to service node 112 of probabilistic model 100 for further processing. Assume for this illustrative example that probabilistic model 100 includes two branches off of service node 112, namely: good service branch 122 and bad service branch 124.

Good service branch 122 may lead to good service node 126, which may be configured to process the portion of content 56 (e.g. unstructured text-based customer feedback) that concerns (in whole or in part) good feedback concerning the customer service of store 58. For example, good service node 126 may define good service word list 128 that may include e.g., the word good, as well as synonyms of (and words related to) the word good (e.g., courteous, friendly, lovely, happy, and smiling). Accordingly and in the event that a portion of content 56 (e.g., a text-based customer feedback message) that was routed to service node 112 includes the word good, courteous, friendly, lovely, happy, and/or smiling, that portion of content 56 may be considered to be text-based customer feedback indicative of good service received at store 58 (and, therefore, may be routed to good service node 126).

Bad service branch 124 may lead to bad service node 130, which may be configured to process the portion of content 56 (e.g. unstructured text-based customer feedback) that concerns (in whole or in part) bad feedback concerning the customer service of store 58. For example, bad service node 130 may define bad service word list 132 that may include e.g., the word bad, as well as synonyms of (and words related to) the word bad (e.g., rude, mean, jerk, miserable, and scowling). Accordingly and in the event that a portion of content 56 (e.g., a text-based customer feedback message) that was routed to service node 112 includes the word bad, rude, mean, jerk, miserable, and/or scowling, that portion of content 56 may be considered to be text-based customer feedback indicative of bad service received at store 58 (and, therefore, may be routed to bad service node 130).

As stated above, selection branch 106 may lead to selection node 114, which may be configured to process the portion of content 56 (e.g. unstructured text-based customer feedback) that concerns (in whole or in part) feedback concerning the selection available at store 58. For example, selection node 114 may define selection word list 134 that may include e.g., words indicative of the selection available at store 58. Accordingly and in the event that a portion of content 56 (e.g., a text-based customer feedback message) includes any of the words defined within selection word list 134, that portion of content 56 may be considered to be text-based customer feedback concerning the selection available at store 58 and (therefore) may be routed to selection node 114 of probabilistic model 100 for further processing. Assume for this illustrative example that probabilistic model 100 includes two branches off of selection node 114, namely: good selection branch 136 and bad selection branch 138.

Good selection branch 136 may lead to good selection node 140, which may be configured to process the portion of content 56 (e.g. unstructured text-based customer feedback) that concerns (in whole or in part) good feedback concerning the selection available at store 58. For example, good selection node 140 may define good selection word list 142 that may include words indicative of a good selection at store 58. Accordingly and in the event that a portion of content 56 (e.g., a text-based customer feedback message) that was routed to selection node 114 includes any of the words defined within good selection word list 142, that portion of content 56 may be considered to be text-based customer feedback indicative of a good selection available at store 58 (and, therefore, may be routed to good selection node 140).

Bad selection branch 138 may lead to bad selection node 144, which may be configured to process the portion of content 56 (e.g. unstructured text-based customer feedback) that concerns (in whole or in part) bad feedback concerning the selection available at store 58. For example, bad selection node 144 may define bad selection word list 146 that may include words indicative of a bad selection at store 58. Accordingly and in the event that a portion of content 56 (e.g., a text-based customer feedback message) that was routed to selection node 114 includes any of the words defined within bad selection word list 146, that portion of content 56 may be considered to be text-based customer feedback indicative of a bad selection being available at store 58 (and, therefore, may be routed to bad selection node 144).

As stated above, location branch 108 may lead to location node 116, which may be configured to process the portion of content 56 (e.g. unstructured text-based customer feedback) that concerns (in whole or in part) feedback concerning the location of store 58. For example, location node 116 may define location word list 148 that may include e.g., words indicative of the location of store 58. Accordingly and in the event that a portion of content 56 (e.g., a text-based customer feedback message) includes any of the words defined within location word list 148, that portion of content 56 may be considered to be text-based customer feedback concerning the location of store 58 and (therefore) may be routed to location node 116 of probabilistic model 100 for further processing. Assume for this illustrative example that probabilistic model 100 includes two branches off of location node 116, namely: good location branch 150 and bad location branch 152.

Good location branch 150 may lead to good location node 154, which may be configured to process the portion of content 56 (e.g. unstructured text-based customer feedback) that concerns (in whole or in part) good feedback concerning the location of store 58. For example, good location node 154 may define good location word list 154 that may include words indicative of store 58 being in a good location. Accordingly and in the event that a portion of content 56 (e.g., a text-based customer feedback message) that was routed to location node 116 includes any of the words defined within good location word list 156, that portion of content 56 may be considered to be text-based customer feedback indicative of store 58 being in a good location (and, therefore, may be routed to good location node 154).

Bad location branch 152 may lead to bad location node 158, which may be configured to process the portion of content 56 (e.g. unstructured text-based customer feedback) that concerns (in whole or in part) bad feedback concerning the location of store 58. For example, bad location node 158 may define bad location word list 160 that may include words indicative of store 58 being in a bad location. Accordingly and in the event that a portion of content 56 (e.g., a text-based customer feedback message) that was routed to location node 116 includes any of the words defined within bad location word list 160, that portion of content 56 may be considered to be text-based customer feedback indicative of store 58 being in a bad location (and, therefore, may be routed to bad location node 158).

As stated above, value branch 110 may lead to value node 118, which may be configured to process the portion of content 56 (e.g. unstructured text-based customer feedback) that concerns (in whole or in part) feedback concerning the value received at store 58. For example, value node 118 may define value word list 162 that may include e.g., words indicative of the value received at store 58. Accordingly and in the event that a portion of content 56 (e.g., a text-based customer feedback message) includes any of the words defined within value word list 162, that portion of content 56 may be considered to be text-based customer feedback concerning the value received at store 58 and (therefore) may be routed to value node 118 of probabilistic model 100 for further processing. Assume for this illustrative example that probabilistic model 100 includes two branches off of value node 118, namely: good value branch 164 and bad value branch 166.

Good value branch 164 may lead to good value node 168, which may be configured to process the portion of content 56 (e.g. unstructured text-based customer feedback) that concerns (in whole or in part) good value being received at store 58. For example, good value node 168 may define good value word list 170 that may include words indicative of receiving good value at store 58. Accordingly and in the event that a portion of content 56 (e.g., a text-based customer feedback message) that was routed to value node 118 includes any of the words defined within good value word list 170, that portion of content 56 may be considered to be text-based customer feedback indicative of good value being received at store 58 (and, therefore, may be routed to good value node 168).

Bad value branch 166 may lead to bad value node 172, which may be configured to process the portion of content 56 (e.g. unstructured text-based customer feedback) that concerns (in whole or in part) bad value being received at store 58. For example, bad value node 172 may define bad value word list 174 that may include words indicative of receiving bad value at store 58. Accordingly and in the event that a portion of content 56 (e.g., a text-based customer feedback message) that was routed to value node 118 includes any of the words defined within bad value word list 174, that portion of content 56 may be considered to be text-based customer feedback indicative of bad value being received at store 58 (and, therefore, may be routed to bad value node 172).

Once it is established that good or bad customer feedback was received concerning store 58 (i.e., with respect to the service, the selection, the location or the value), representatives and/or agents of store 58 may address the provider of such good or bad feedback via e.g., social media postings, text-messages and/or personal contact.

Assume for illustrative purposes that a user (e.g., user 36, 38, 40, 42) of the above-stated probabilistic modeling process 10 provides feedback to store 58 in the form of speech provided to an automated feedback phone line. Further assume for this example that user 36 uses data-enabled, cellular telephone 28 to provide feedback 60 (e.g., a portion of content 56) to the automated feedback phone line. Upon receiving feedback 60 for analysis, probabilistic modeling process 10 may identify any pertinent content that is included within feedback 60.

For illustrative purposes, assume that user 36 was not happy with their experience at store 58 and that feedback 60 provided by user 36 was “my cashier was rude and the weather was rainy”. Accordingly and for this example, probabilistic modeling process 10 may identify the pertinent content (included within feedback 60) as the phrase “my cashier was rude” and may ignore/remove the irrelevant content “the weather was rainy”. As (in this example) feedback 60 includes the word “cashier”, probabilistic modeling process 10 may rout feedback 60 to service node 112 via service branch 104. Further, as feedback 60 also includes the word “rude”, probabilistic modeling process 10 may rout feedback 60 to bad service node 130 via bad service branch 124 and may consider feedback 60 to be text-based customer feedback indicative of bad service being received at store 58.

For further illustrative purposes, assume that user 36 was happy with their experience at store 58 and that feedback 60 provided by user 36 was “the clothing I purchased was classy but my cab got stuck in traffic”. Accordingly and for this example, probabilistic modeling process 10 may identify the pertinent content (included within feedback 60) as the phrase “the clothing I purchased was classy” and may ignore/remove the irrelevant content “my cab got stuck in traffic”. As (in this example) feedback 60 includes the word “clothing”, probabilistic modeling process 10 may rout feedback 60 to selection node 114 via selection branch 106. Further, as feedback 60 also includes the word “classy”, probabilistic modeling process 10 may rout feedback 60 to good selection node 140 via good selection branch 136 and may consider feedback 60 to be text-based customer feedback indicative of a good selection being available at store 58.

### Model Generation Overview:

While the following discussion concerns the automated generation of a probabilistic model, this is for illustrative purposes only and is not intended to be a limitation of this disclosure, as other configurations are possible and are considered to be within the scope of this disclosure. For example, the following discussion of automated generation may be utilized on any type of model. For example, the following discussion may be applicable to any other form of probabilistic model or any form of generic model (such as Dempster Shaffer theory or fuzzy logic).

As discussed above, probabilistic model 100 may be utilized to categorize content 56, thus allowing the various messages included within content 56 to be routed to (in this simplified example) one of eight nodes (e.g., good service node 126, bad service node 130, good selection node 140, bad selection node 144, good location node 154, bad location node 158, good value node 168, and bad value node 172). For the following example, assume that store 58 is a long-standing and well established shopping establishment. Further, assume that content 56 is a very large quantity of voice mail messages (>10,000 messages) that were left by customers of store 58 on a voice-based customer feedback line. Additionally, assume that this very large quantity of voice mail messages (>10,000) have been transcribed into a very large quantity of text-based messages (>10,000).

Probabilistic modeling process 10 may be configured to automatically define probabilistic model 100 based upon content 56. Accordingly, probabilistic modeling process 10 may receive content (e.g., a very large quantity of text-based messages). Probabilistic modeling process 10 may be configured to define one or more probabilistic model variables for probabilistic model 100. For example, probabilistic modeling process 10 may be configured to allow a user of probabilistic modeling process 10 to specify such probabilistic model variables. Another example of such variables may include but is not limited to values and/or ranges of values for a data flow variable. For the following discussion and for this disclosure, examples of “variable” may include but are not limited to variables, parameters, ranges, branches and nodes.

Specifically and for this example, assume that probabilistic modeling process 10 defines the initial number of branches (i.e., the number of branches off of branching node 102) within probabilistic model 100 as four (i.e., service branch 104, selection branch 106, location branch 108 and value branch 110). When defining the initial number of branches (i.e., the number of branches off of branching node 102) within probabilistic model 100 as four, this may be effectuated in various ways (e.g., manually or algorithmically). Further and when defining probabilistic model 100 based, at least in part, upon content 56 and the one or more model variables (i.e., defining the number of branches off of branching node 102 as four), probabilistic modeling process 10 may process content 56 to identify the pertinent content included within content 56. As discussed above, probabilistic modeling process 10 may identify the pertinent content (included within content 56) and may ignore/remove the irrelevant content.

This type of processing of content 56 may continue for all of the very large quantity of text-based messages (>10,000) included within content 56. And using the probabilistic modeling technique described above, probabilistic modeling process 10 may define a first version of the probabilistic model (e.g., probabilistic model 100) based, at least in part, upon pertinent content found within content 56. Accordingly, a first text-based message included within content 56 may be processed to extract pertinent information from that first message, wherein this pertinent information may be grouped in a manner to correspond (at least temporarily) with the requirement that four branches originate from branching node 102 (as defined above).

As probabilistic modeling process 10 continues to process content 56 to identify pertinent content included within content 56, probabilistic modeling process 10 may identify patterns within these text-based message included within content 56. For example, the messages may all concern one or more of the service, the selection, the location and/or the value of store 58. Further and e.g., using the probabilistic modeling technique described above, probabilistic modeling process 10 may process content 56 to e.g.: a) sort text-based messages concerning the service into positive or negative service messages; b) sort text-based messages concerning the selection into positive or negative selection messages; c) sort text-based messages concerning the location into positive or negative location messages; and/or d) sort text-based messages concerning the value into positive or negative service messages. For example, probabilistic modeling process 10 may define various lists (e.g., lists 128, 132, 142, 146, 156, 160, 170, 174) by starting with a root word (e.g., good or bad) and may then determine synonyms for these words and use those words and synonyms to populate lists 128, 132, 142, 146, 156, 160, 170, 174.

Continuing with the above-stated example, once content 56 (or a portion thereof) is processed by probabilistic modeling process 10, probabilistic modeling process 10 may define a first version of the probabilistic model (e.g., probabilistic model 100) based, at least in part, upon pertinent content found within content 56. Probabilistic modeling process 10 may compare the first version of the probabilistic model (e.g., probabilistic model 100) to content 56 to determine if the first version of the probabilistic model (e.g., probabilistic model 100) is a good explanation of the content.

When determining if the first version of the probabilistic model (e.g., probabilistic model 100) is a good explanation of the content, probabilistic modeling process 10 may use an ML algorithm to fit the first version of the probabilistic model (e.g., probabilistic model 100) to the content, wherein examples of such an ML algorithm may include but are not limited to one or more of: an inferencing algorithm, a learning algorithm, an optimization algorithm, and a statistical algorithm.

For example and as is known in the art, probabilistic model 100 may be used to generate messages (in addition to analyzing them). For example and when defining a first version of the probabilistic model (e.g., probabilistic model 100) based, at least in part, upon pertinent content found within content 56, probabilistic modeling process 10 may define a weight for each branch within probabilistic model 100 based upon content 56. For example, probabilistic modeling process 10 may equally weight each of branches 104, 106, 108, 110 at 25%. Alternatively, if e.g., a larger percentage of content 56 concerned the service received at store 58, probabilistic modeling process 10 may equally weight each of branches 106, 108, 110 at 20%, while more heavily weighting branch 104 at 40%.

Accordingly and when probabilistic modeling process 10 compares the first version of the probabilistic model (e.g., probabilistic model 100) to content 56 to determine if the first version of the probabilistic model (e.g., probabilistic model 100) is a good explanation of the content, probabilistic modeling process 10 may generate a very large quantity of messages e.g., by auto-generating messages using the above-described probabilities, the above-described nodes & node types, and the words defined in the above-described lists (e.g., lists 128, 132, 142, 146, 156, 160, 170, 174), thus resulting in generated content 56′. Generated content 56′ may then be compared to content 56 to determine if the first version of the probabilistic model (e.g., probabilistic model 100) is a good explanation of the content. For example, if generated content 56′ exceeds a threshold level of similarity to content 56, the first version of the probabilistic model (e.g., probabilistic model 100) may be deemed a good explanation of the content. Conversely, if generated content 56′ does not exceed a threshold level of similarity to content 56, the first version of the probabilistic model (e.g., probabilistic model 100) may be deemed not a good explanation of the content.

If the first version of the probabilistic model (e.g., probabilistic model 100) is not a good explanation of the content, probabilistic modeling process 10 may define a revised version of the probabilistic model (e.g., revised probabilistic model 100′). When defining revised probabilistic model 100′, probabilistic modeling process 10 may e.g., adjust weighting, adjust probabilities, adjust node counts, adjust node types, and/or adjust branch counts to define the revised version of the probabilistic model (e.g., revised probabilistic model 100′). Once defined, the above-described process of auto-generating messages (this time using revised probabilistic model 100′) may be repeated and this newly-generated content (e.g., generated content 56″) may be compared to content 56 to determine if e.g., revised probabilistic model 100′ is a good explanation of the content. If revised probabilistic model 100′ is not a good explanation of the content, the above-described process may be repeated until a proper probabilistic model is defined.

Machine Modelling Process

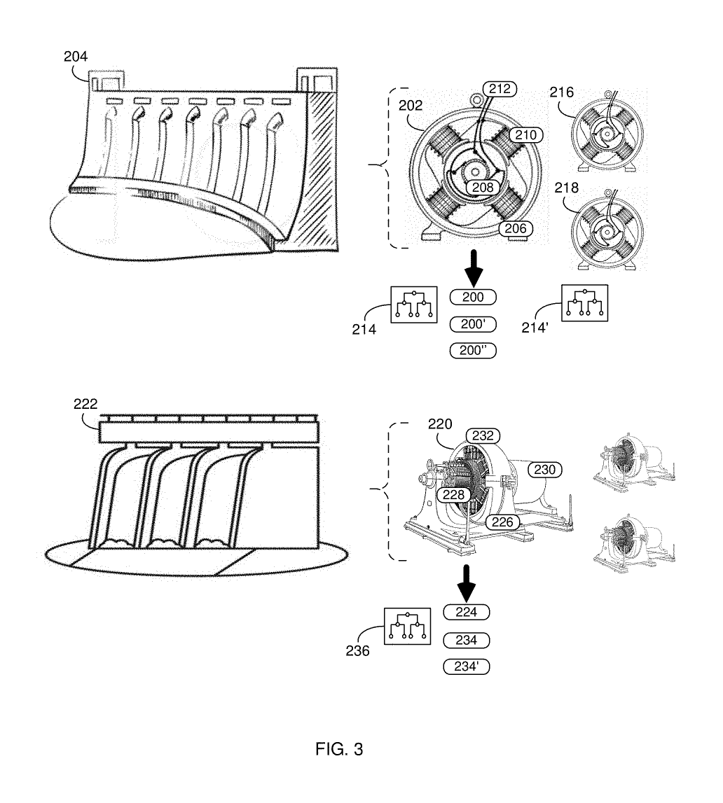

Referring also to FIG. 3 and as will be discussed below in greater detail, probabilistic modeling process 10 may be configured to process observed data 200 from various electricity-producing machines (e.g., generator 202) so that probabilistic models of these electricity-producing machines (e.g., generator 202) may be generated and used to predict future operational performance data for these electricity-producing machines (e.g., generator 202). An example of the electricity-producing machines (e.g., generator 202) may include but is not limited to any component of an electricity generation system included within a hydroelectric dam (e.g., hydroelectric dam 204), examples of which may include but are not limited to: a generator, a turbine, an exciter, a governor, a shaft system, bearings and/or associated water passages.

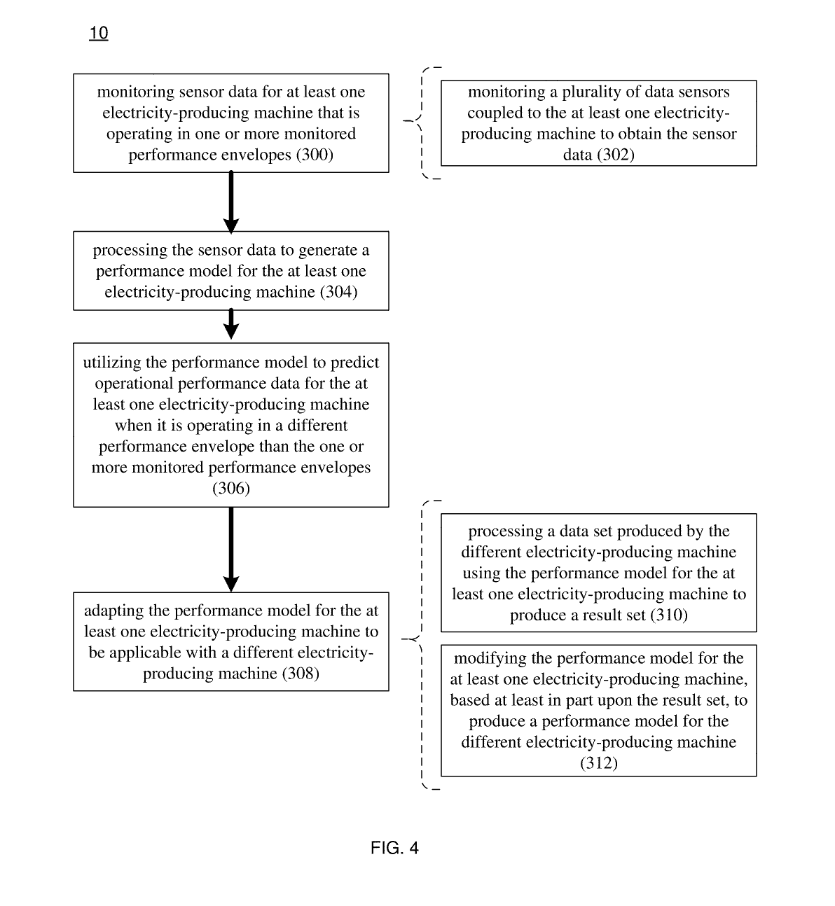

Referring also to FIG. 4, probabilistic modeling process 10 may monitor 300 observed data (e.g., observed data 200) for at least one electricity-producing machines (e.g., generator 202) that is operating in one or more monitored performance envelopes. Examples of such performance envelopes may include any envelope that defines the manner in which the electricity-producing machines (e.g., generator 202) is operating.

When monitoring 300 observed data (e.g., observed data 200) for at least one electricity-producing machines (e.g., generator 202) that is operating in one or more monitored performance envelopes, probabilistic modeling process 10 may monitor 302 the plurality of data sensors (e.g., data sensors 206, 208, 210, 212) coupled to the at least one electricity-producing machines (e.g., generator 202) to obtain the observed data (e.g., observed data 200).

So assume that sensor 206 is a stator temperature sensor, sensor 208 is a rotor temperature sensor, sensor 210 is a housing temperature sensor, and sensor 212 is an output sensor. Accordingly and during the use of the electricity-producing machine (e.g., generator 202), the stator temperature may be monitored with sensor 206, the rotor temperature may be monitored with sensor 208, the housing temperature may be monitored with sensor 210, and the output may be monitored with sensor 212.

Accordingly, the various performance envelopes for the electricity-producing machines (e.g., generator 202) may define e.g., that:
the electricity-producing machines (e.g., generator 202) is operating at 50% of its output capacity, with a stator temperature of 240 degrees, a rotor temperature of 220 degrees, and an housing temperature of 92 degrees;
the electricity-producing machines (e.g., generator 202) is operating at 75% of its output capacity, with a stator temperature of 270 degrees, a rotor temperature of 250 degrees, and an housing temperature of 97 degrees; and
the electricity-producing machines (e.g., generator 202) is operating at 99% of its output capacity, with a stator temperature of 310 degrees, a rotor temperature of 260 degrees, and an housing temperature of 102 degrees.

Probabilistic modeling process 10 may process 304 the observed data (e.g., observed data 200) to generate a performance model (e.g., probabilistic model 214) for the at least one electricity-producing machines (e.g., generator 202).

As discussed above, probabilistic modeling process 10 may be configured to automatically define a probabilistic model (e.g., probabilistic model 214) based upon (in this example) the observed data (e.g., observed data 200). Assume for this example that the observed data (e.g., observed data 200) is a very large set of data received from the electricity-producing machine (e.g., generator 202). Further assume for this example that the observed data (e.g., observed data 200) may be gathered from one or more additional electricity-producing machine (e.g., generators 216, 218).

Continuing with the above-stated example, probabilistic modeling process 10 may receive the observed data (e.g., observed data 200) and may define one or more probabilistic model variables for the performance model (e.g., probabilistic model 214) for the at least one electricity-producing machines (e.g., generator 202). For example, probabilistic modeling process 10 may be configured to allow a user of probabilistic modeling process 10 to specify such probabilistic model variables, wherein examples of such “variables” may include but are not limited to variables, parameters, ranges, branches and nodes.

This type of processing of the observed data (e.g., observed data 200) may continue for all of the content included within the observed data (e.g., observed data 200). And using the probabilistic modeling technique described above, probabilistic modeling process 10 may define a first version of the performance model (e.g., probabilistic model 214) based, at least in part, upon pertinent content found within the observed data (e.g., observed data 200). As discussed above, as probabilistic modeling process 10 continues to process the observed data (e.g., observed data 200) to identify pertinent content included within the observed data (e.g., observed data 200), probabilistic modeling process 10 may identify patterns within the observed data (e.g., observed data 200).

Continuing with the above-stated example, once the observed data (e.g., observed data 200) is processed by probabilistic modeling process 10, probabilistic modeling process 10 may define a first version of the performance model (e.g., probabilistic model 214) based, at least in part, upon pertinent content found within the observed data (e.g., observed data 200). Probabilistic modeling process 10 may compare the first version of the performance model (e.g., probabilistic model 214) to the observed data (e.g., observed data 200) to determine if the first version of the performance model (e.g., probabilistic model 214) is a good explanation of the observed data (e.g., observed data 200).

As discussed above and when determining if the first version of the performance model (e.g., probabilistic model 214) is a good explanation of the observed data (e.g., observed data 200), probabilistic modeling process 10 may use an ML algorithm to fit the first version of the performance model (e.g., probabilistic model 214) to the observed data (e.g., observed data 200), wherein examples of such an ML algorithm may include but are not limited to one or more of: an inferencing algorithm, a learning algorithm, an optimization algorithm, and a statistical algorithm.

As discussed above and as is known in the art, the performance model (e.g., probabilistic model 214) may be used to generate data (in addition to analyzing data).

For example and when defining a first version of the performance model (e.g., probabilistic model 214) based, at least in part, upon pertinent content found within the observed data (e.g., observed data 200), probabilistic modeling process 10 may define a weight for each branch within the performance model (e.g., probabilistic model 214) based upon the observed data (e.g., observed data 200).

Accordingly and when probabilistic modeling process 10 compares the first version of the performance model (e.g., probabilistic model 214) to the observed data (e.g., observed data 200) to determine if the first version of the performance model (e.g., probabilistic model 214) is a good explanation of the observed data (e.g., observed data 200), probabilistic modeling process 10 may generate a very large quantity of data e.g., by auto-generating data in the manner described above, thus resulting in generated observed data (e.g., generated observed data 200′). Generated observed data 200′ may then be compared to observed data 200 to determine if the first version of the performance model (e.g., probabilistic model 214) is a good explanation of the observed data (e.g., observed data 200). For example, if generated observed data 200′ exceeds a threshold level of similarity to the observed data (e.g., observed data 200), the first version of the performance model (e.g., probabilistic model 214) may be deemed a good explanation of the observed data (e.g., observed data 200). Conversely, if generated observed data 200′ does not exceed a threshold level of similarity to the observed data (e.g., observed data 200), the first version of the performance model (e.g., probabilistic model 214) may be deemed not a good explanation of the observed data (e.g., observed data 200).

If the first version of the performance model (e.g., probabilistic model 214) is not a good explanation of the observed data (e.g., observed data 200), probabilistic modeling process 10 may define a revised version the performance model (e.g., probabilistic model 214′). When defining the revised version the performance model (e.g., probabilistic model 214′), probabilistic modeling process 10 may e.g., adjust weighting, adjust probabilities, adjust node counts, adjust node types, and/or adjust branch counts to define the revised version the performance model (e.g., probabilistic model 214′). Once defined, the above-described process of auto-generating data (this time using the revised version the performance model (e.g., probabilistic model 214′) may be repeated and this newly-generated data (e.g., generated observed data 200″) may be compared to the observed data (e.g., observed data 200) to determine if e.g., probabilistic model 214′ is a good explanation of the observed data (e.g., observed data 200). If the revised version the performance model (e.g., probabilistic model 214′) is not a good explanation of the observed data (e.g., observed data 200), the above-described process may be repeated until a proper performance model is defined.

Assume for illustrative purposes that the revised version the performance model (e.g., probabilistic model 214′) is a good explanation of the observed data (e.g., observed data 200). Probabilistic modeling process 10 may utilize 306 the performance model (e.g., probabilistic model 214′) to predict operational performance data for the at least one electricity-producing machines (e.g., generator 202) when it is operating in a different performance envelope than the one or more monitored performance envelopes (as described above).

The operational performance data predicted by the performance model (e.g., probabilistic model 214′) may include one or more of:
sensor data for the at least one electricity-producing machines (e.g., generator 202) when it is operating in the different performance envelope;
longevity data for the at least one electricity-producing machines (e.g., generator 202) when it is operating in the different performance envelope;
efficiency data for the at least one electricity-producing machines (e.g., generator 202) when it is operating in the different performance envelope;
output data for the at least one electricity-producing machines (e.g., generator 202) when it is operating in the different performance envelope; and
maintenance data for the at least one electricity-producing machines (e.g., generator 202) when it is operating in the different performance envelope.

For example, probabilistic modeling process 10 may utilize 306 the performance model (e.g., probabilistic model 214′) to predict operational performance data for the at least one electricity-producing machines (e.g., generator 202) when it is asked to operate at 110% of its output capacity. In other words, the performance model (e.g., probabilistic model 214′) may be utilized to predict a stator temperature, and/or a rotor temperature, and/or a housing temperature.

Suppose the observed data (e.g., observed data 200) also includes other types of data, examples of which may include but are not limited to data concerning component failures within generator 202 (e.g., stator failures, rotor failures, bearing failures, impellor failures, etc.), and maintenance performed on generator 202 (e.g., the cleaning of certain components, the oiling of certain components, etc.).

Accordingly, probabilistic modeling process 10 may utilize 306 the performance model (e.g., probabilistic model 214′) to predict when a main shaft bearing will fail if the at least one electricity-producing machines (e.g., generator 202) is asked to operate at 110% of its output capacity. Further, probabilistic modeling process 10 may utilize 306 the performance model (e.g., probabilistic model 214′) to predict how a maintenance schedule for a heat exchanger may be impacted if the at least one electricity-producing machines (e.g., generator 202) is asked to operate at 110% of its output capacity. Additionally, probabilistic modeling process 10 may utilize 306 the performance model (e.g., probabilistic model 214′) to predict how the efficiency of generator 202 may be impacted if the at least one electricity-producing machines (e.g., generator 202) is asked to operate at 110% of its output capacity.

While probabilistic modeling process 10 is described above as utilizing 306 the performance model (e.g., probabilistic model 214′) to predict operational performance data for the at least one electricity-producing machines (e.g., generator 202) when it is operating in a different performance envelope than the one or more monitored performance envelopes (as described above), this is for illustrative purposes only and is not intended to be a limitation of this disclosure, as other configuration are possible and are considered to be within the scope of this disclosure. For example, probabilistic modeling process 10 may utilize the performance model (e.g., probabilistic model 214′) to predict operational performance data for the at least one electricity-producing machines (e.g., generator 202) when it is operating in the same performance envelope (e.g., one or more monitored performance envelopes described above).

Accordingly, probabilistic modeling process 10 may utilize the performance model (e.g., probabilistic model 214′) to predict when a main shaft bearing will fail if the at least one electricity-producing machines (e.g., generator 202) continues to operate at 99% of its output capacity. Further, probabilistic modeling process 10 may utilize the performance model (e.g., probabilistic model 214′) to predict how a maintenance schedule for a heat exchanger may be impacted if the at least one electricity-producing machines (e.g., generator 202) continues to operate at 99% of its output capacity. Additionally, probabilistic modeling process 10 may utilize the performance model (e.g., probabilistic model 214′) to predict how the efficiency of generator 202 may be impacted if the at least one electricity-producing machines (e.g., generator 202) continues to operate at 99% of its output capacity.

Machine Model Adaptation

Probabilistic modeling process 10 may adapt 308 the performance model (e.g., probabilistic model 214′) for the at least one electricity-producing machines (e.g., generator 202) to be applicable with a different electricity-producing machines (e.g., generator 220). An example of the different electricity-producing machine (e.g., generator 220) may include but is not limited to a different type/brand of generator that is included within a different hydroelectric dam (e.g., hydroelectric dam 222).

When adapting 308 the performance model (e.g., probabilistic model 214′) for the at least one electricity-producing machines (e.g., generator 202) to be applicable with the different electricity-producing machine (e.g., generator 220), probabilistic modeling process 10 may use the performance model (e.g., probabilistic model 214′) for the at least one electricity-producing machines (e.g., generator 202) as a starting point for the performance model for the different electricity-producing machine (e.g., generator 220).

For example, a data set (e.g., observed data 224) may be produced by the different electricity-producing machines (e.g., generator 220), wherein the data set (e.g., observed data 224) produced by the different electricity-producing machines (e.g., generator 220) may be obtained by monitoring a plurality of data sensors (e.g., data sensors 226, 228, 230, 232) coupled to the different electricity-producing machines (e.g., generator 220).

Probabilistic modeling process 10 may process 310 this data set (e.g., observed data 224) produced by the different electricity-producing machines (e.g., generator 220) using (as a starting point) the performance model (e.g., probabilistic model 214′) for the at least one electricity-producing machines (e.g., generator 202) to produce a result set (e.g., result set 234).

Further and when adapting 308 the performance model (e.g., probabilistic model 214′) for the at least one electricity-producing machines (e.g., generator 202) to be applicable with a different electricity-producing machines (e.g., generator 220), probabilistic modeling process 10 may modify 312 the performance model (e.g., probabilistic model 214′) for the at least one electricity-producing machines (e.g., generator 202), based at least in part upon the result set (e.g., result set 234), to produce a performance model (e.g., probabilistic model 236) for the different electricity-producing machines (e.g., generator 220).

Specifically, probabilistic modeling process 10 may generate a very large quantity of data e.g., by auto-generating data in the manner described above, thus resulting in the generation of the result set (e.g., result set 234). The result set (e.g., result set 234) may then be compared to observed data 224 to determine if the performance model (e.g., probabilistic model 214′) is a good explanation of the observed data (e.g., observed data 224). For example, if the result set (e.g., result set 234) exceeds a threshold level of similarity to the observed data (e.g., observed data 224), the performance model (e.g., probabilistic model 214′) may be deemed a good explanation of the observed data (e.g., observed data 224). Conversely, if the result set (e.g., result set 234) does not exceed a threshold level of similarity to the observed data (e.g., observed data 224), the performance model (e.g., probabilistic model 214′) may be deemed not a good explanation of the observed data (e.g., observed data 224).

If the probabilistic model (e.g., probabilistic model 214′) is not a good explanation of the observed data (e.g., observed data 224), probabilistic modeling process 10 may define a revised performance model (e.g., probabilistic model 236). When defining the revised performance model (e.g., probabilistic model 236), probabilistic modeling process 10 may e.g., adjust weighting, adjust probabilities, adjust node counts, adjust node types, and/or adjust branch counts to define the revised performance model (e.g., probabilistic model 236). Once defined, the above-described process of auto-generating data (this time using probabilistic model 236) may be repeated and this newly-generated content (e.g., generated content 234′) may be compared to the observed data (e.g., observed data 224) to determine if e.g., the revised performance model (e.g., probabilistic model 236) is a good explanation of the observed data (e.g., observed data 224). If the revised performance model (e.g., probabilistic model 236) is not a good explanation of the observed data (e.g., observed data 224), the above-described process may be repeated until a proper probabilistic model is defined.

### GENERAL

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
monitoring observed data for at least one electricity-producing machine that is operating in one or more monitored performance envelopes; and
processing the observed data to generate a performance model for the at least one electricity-producing machine.

2. The computer-implemented method of claim 1 further comprising:
adapting the performance model for the at least one electricity-producing machine to be applicable with a different electricity-producing machine.

3. The computer-implemented method of claim 2 wherein adapting the performance model for the at least one electricity-producing machine to be applicable with a different electricity-producing machine includes:
processing a data set produced by the different electricity-producing machine using the performance model for the at least one electricity-producing machine to produce a result set.

4. The computer-implemented method of claim 3 wherein adapting the performance model for the at least one electricity-producing machine to be applicable with a different electricity-producing machine further includes:
modifying the performance model for the at least one electricity-producing machine, based at least in part upon the result set, to produce a performance model for the different electricity-producing machine.

5. The computer-implemented method of claim 1 further comprising:
utilizing the performance model to predict operational performance data for the at least one electricity-producing machine when it is operating in a different performance envelope than the one or more monitored performance envelopes.

6. The computer-implemented method of claim 5 wherein the operational performance data includes one or more of:
sensor data for the at least one electricity-producing machine when it is operating in the different performance envelope;
longevity data for the at least one electricity-producing machine when it is operating in the different performance envelope;
efficiency data for the at least one electricity-producing machine when it is operating in the different performance envelope;
output data for the at least one electricity-producing machine when it is operating in the different performance envelope; and
maintenance data for the at least one electricity-producing machine when it is operating in the different performance envelope.

7. The computer-implemented method of claim 1 wherein monitoring observed data for at least one electricity-producing machine that is operating in one or more monitored performance envelopes includes:
monitoring a plurality of data sensors coupled to the at least one electricity-producing machine to obtain the observed data.

8. A computer program product residing on a computer readable medium having a plurality of instructions stored thereon which, when executed by a processor, cause the processor to perform operations comprising:
monitoring observed data for at least one electricity-producing machine that is operating in one or more monitored performance envelopes; and
processing the observed data to generate a performance model for the at least one electricity-producing machine.

9. The computer program product of claim 8 further comprising:
adapting the performance model for the at least one electricity-producing machine to be applicable with a different electricity-producing machine.

10. The computer program product of claim 9 wherein adapting the performance model for the at least one electricity-producing machine to be applicable with a different electricity-producing machine includes:
processing a data set produced by the different electricity-producing machine using the performance model for the at least one electricity-producing machine to produce a result set.

11. The computer program product of claim 10 wherein adapting the performance model for the at least one electricity-producing machine to be applicable with a different electricity-producing machine further includes:
modifying the performance model for the at least one electricity-producing machine, based at least in part upon the result set, to produce a performance model for the different electricity-producing machine.

12. The computer program product of claim 18 further comprising:
utilizing the performance model to predict operational performance data for the at least one electricity-producing machine when it is operating in a different performance envelope than the one or more monitored performance envelopes.

13. The computer program product of claim 12 wherein the operational performance data includes one or more of:
sensor data for the at least one electricity-producing machine when it is operating in the different performance envelope;
longevity data for the at least one electricity-producing machine when it is operating in the different performance envelope;
efficiency data for the at least one electricity-producing machine when it is operating in the different performance envelope;
output data for the at least one electricity-producing machine when it is operating in the different performance envelope; and
maintenance data for the at least one electricity-producing machine when it is operating in the different performance envelope.

14. The computer program product of claim 8 wherein monitoring observed data for at least one electricity-producing machine that is operating in one or more monitored performance envelopes includes:
monitoring a plurality of data sensors coupled to the at least one electricity-producing machine to obtain the observed data.

15. A computing system including a processor and memory configured to perform operations comprising:
monitoring observed data for at least one electricity-producing machine that is operating in one or more monitored performance envelopes; and
processing the observed data to generate a performance model for the at least one electricity-producing machine.

16. The computing system of claim 15 further comprising:
adapting the performance model for the at least one electricity-producing machine to be applicable with a different electricity-producing machine.

17. The computing system of claim 16 wherein adapting the performance model for the at least one electricity-producing machine to be applicable with a different electricity-producing machine includes:
processing a data set produced by the different electricity-producing machine using the performance model for the at least one electricity-producing machine to produce a result set.

18. The computing system of claim 17 wherein adapting the performance model for the at least one electricity-producing machine to be applicable with a different electricity-producing machine further includes:
modifying the performance model for the at least one electricity-producing machine, based at least in part upon the result set, to produce a performance model for the different electricity-producing machine.

19. The computing system of claim 15 further comprising:
utilizing the performance model to predict operational performance data for the at least one electricity-producing machine when it is operating in a different performance envelope than the one or more monitored performance envelopes.

20. The computing system of claim 19 wherein the operational performance data includes one or more of:
sensor data for the at least one electricity-producing machine when it is operating in the different performance envelope;
longevity data for the at least one electricity-producing machine when it is operating in the different performance envelope;
efficiency data for the at least one electricity-producing machine when it is operating in the different performance envelope;
output data for the at least one electricity-producing machine when it is operating in the different performance envelope; and
maintenance data for the at least one electricity-producing machine when it is operating in the different performance envelope.

21. The computing system of claim 15 wherein monitoring observed data for at least one electricity-producing machine that is operating in one or more monitored performance envelopes includes:
monitoring a plurality of data sensors coupled to the at least one electricity-producing machine to obtain the observed data.
